(19) United States
(12) Patent Application Publication
(10) Pub. No.: US 2009/0095573 A1
(43) Pub. Date: Apr. 16, 2009

(54) Forklift strike plate attachment

(76) Inventor: Elbert Goins, Cecilia, KY (US)

Correspondence Address: R. Christian Macke, 40 East 10th Street, Newport, KY, 41071, US

(21) Appl. No.: 11/474,606

(22) Filed: Jun. 26, 2006

(51) Int. Cl. B66F 9/12

(52) U.S. Cl. 187/238

(57) ABSTRACT

An apparatus and method directed to modifying conventional forklift trucks to reduce or eliminate damage to pallets. A strike plate of sufficient width is secured to the upper and lower carriage rails of a forklift between the two forks of the forklift, positioned on the carriage rails such that the strike plate engages a structural member of the pallet. Damage from overtravel of the forks into the pallet is prevented because the protective strike plate will cause the whole pallet to move before the forks have the chance to rip up the first couple of deck boards on the top of the pallet. The strike plate is attached to forklifts having an upper carriage rail and a lower carriage rail. A permanently affixed latch is located near the top of the strike plate to engage the upper carriage bar, and a latch piece separable from the strike plate is provided to affix the bottom of the strike plate to the lower carriage rail. The means for securing the strike plate to the upper and lower carriage rails is completely accessible from the front of the forklift, and does not require any modifications on or to the rear of the upper or lower carriage rails.

### FIELD OF THE INVENTION

This invention relates to an attachment to a forklift truck that reduces damage to pallets engaged by the forklift.

### BACKGROUND OF THE INVENTION

Material handling by heavy equipment occurs every day in thousands of warehouses around the world. One of the most common kinds of material handling is accomplished by positioning goods or materials onto a pallet and then using a forklift to pick up and move the pallet and the goods or materials thereon.

Typically, a forklift is a counterweighted vehicle/truck having two L shaped forks, comprising vertical members and outwardly extending horizontal legs. The horizontal legs of the forks engage the object or pallet to be transported and then move in a vertical direction along a vertical carriage to lift and lower items laying on the forks, including, without limitation, pallets with goods or materials positioned thereon.

The most common application of forklifts, to pick up and move goods and materials, is done by positioning the goods and materials on pallets which are readily engaged by the forks of the forklift. Generally, a pallet comprises multiple wood planks forming a lower deck and multiple wood planks forming an upper deck, the lower deck and upper deck connected to, and sandwiching, structural elements between them. The lengths of the structural elements run perpendicular to the lengths of the wood planks forming the upper and lower decks. Typically, three structural elements are used, two at opposed outer edges of the wood planks forming the upper and lower decks and the third in the middle, resulting in two voids being formed on opposite sides of the middle structural member.

The forklift and pallet are used cooperatively by driving the forklift forward such that the spaced apart forks line up with and engage the voids in the pallet. This cooperative use provides a very effective means for transporting heavy loads of goods and materials positioned on a pallet.

However, there are disadvantages and problems with forklift material handling of palleted loads that have not been adequately addressed. The problems are most apparent under the most stressful conditions, i.e. when the forklifts and operators are forced to deal with heavy loads. Under such heavy loading conditions, care is exercised in the positioning of the load on the forklift because, when a heavy load is lifted, if the center of gravity is not properly positioned on the forks against the counterweight of the forklift, the load and forklift may tip over, presenting a risk of serious injury or death to the operator and damage to the load. To that end, operators will typically make every effort to get the load fully onto the forks, driving the forklift forward so that the forks completely penetrate the voids in the pallet. The negative outcome of this practice is that, often, the operator overtravels to ensure complete penetration, going forward until they detect the vertical members of the L-shaped fork engaging the pallet. Because the operator is seated behind the carriage and forks, visual confirmation of the forks engaging the pallet is not available, so operators frequently drive the forklift until they see that the load has moved as a result of being struck by the forklift. This is generally a precaution taken by forklift operators; it is better to orr on the side of overtravel, and to get the load completely onto the forks, than to undertravel and have a load cantilevered out on the end of the fork.

The problem with overtravelling to ensure complete engagement of the pallet is the damage that results to the pallet. That is, prior to the vertical member of the L-shaped fork engaging the pallet, the bend in the fork, between the horizontal leg and the vertical member, engages the planks in the upper deck of the pallet. When this occurs, and as the forklift continues to move forward, the deck planks are ripped away from the structural members. The result is a damaged or ruined pallet which, in the best case, must be repaired by hammering or nailing the deck plank or planks back into place. If multiple planks are ripped off, the pallet may be ruined or, worse, the load destabilized, resulting in increased danger of load shifting and the forklift tipping.

There is thus identified a need for a device attaching to a forklift that prevents overtravel of the forks into a pallet. This can be accomplished by providing a strike plate between the forks that engages the pallet prior to the bend of the forks ripping planks off of the top deck. It is desirable to make such strike plate of a simple, but sturdy material, while also providing simple and accessible means for rigidly attaching it to a forklift.

Prior attempts to provide such a strike plate for forklifts include U.S. Pat. No. 5,560,451, in which a lower bumper was applied only to the lower carriage rail of the forklift. This arrangement includes a difficult and time consuming means for attachment to the forklift lower carriage rail, specifically the drilling of holes in the lower carriage rail to receive bolts that pass through clearance holes 68 formed in the strike plate (FIG. 3). The holes in the lower carriage beam must be located, drilled and tapped to hold the strike plate bumper on.

In U.S. Pat. No. 4,102,464, a strike plate is added to forklift by laying latch members over the upper carriage rail while a block 33 is bolted to the bottom of the strike plate to hold it against the lower carriage rail (see FIG. 2). The '464 arrangement has the serious deficiency of requiring access to the back side of the strike plate and carriage beam to attach, tighten or loosen bolts 35 (FIG. 2).

The present invention provides a strike plate that is sturdy and which rigidly, securely and easily attaches to forklifts and which cooperates with toothed carriage rails to securely hold the strike plate in position and to preclude any possible lateral translation across the carriage beams.

### OBJECTS OF THE INVENTION

It is an object of the present invention to provide a forklift attachment designed to prevent damage to pallets caused when forks engage the deck planks of the pallet.

It is another object of the present invention to provide a strike plate for attaching to a forklift that prevents damage to pallets engaged by the forklift.

It is yet another object of the present invention to provide a forklift attachment that prevents fork overtravel into the pallet.

It is a further object of the present invention to provide a forklift attachment that is quickly and easily attached to and detached from a forklift that prevents overtravel of the forks into pallets engaged by the forklift.

It is a further object of the present invention to provide a forklift attachment having front accessibility for ease of attachment and detachment from the forklift.

It is yet another object of the present invention to provide a strike plate attachment that locks onto cooperative elements of the forklift to hold the strike plate rigidly in place, preventing lateral translation.

These and other objects and advantages of the present invention will be apparent from a review of the following specification and accompanying drawings.

### SUMMARY OF THE INVENTION

The present invention provides a strike plate for a forklift having at least one carriage rail. The strike plate comprises an elongated plate and a means for securing the elongated plate to a carriage rail of the forklift. In a significant feature of the present invention, the means for securing the strike plate to the carriage rail are accessible from the front of the forklift.

The means for securing the strike plate to the carriage rail also comprises at least one latch block that is separable and detachable from the strike plate. When installed, the strike plate is bolted to the latch block to tightly pinch the carriage rail therebetween. The means for securing the strike plate to the carriage rail further comprises a permanently affixed latch block which is affixed to the strike plate at the end opposed end to the end that is bolted to the separable latch block.

In the most preferred embodiment of the present invention, the separable latch block further comprises a threaded sleeve which is aligned with a through sleeve in the strike plate to receive a locking bolt and means for clamping the strike plate to the carriage rail. The strike plate of the present invention further comprises a recessed collar in the through sleeve such that the head of the locking bolt is flush or below the strike surface of the strike plate.

In use, the strike plate of the present invention, when secured to a forklift, prevents the forks from ripping deck boards off of pallets because the strike plate engages the middle structural member of the pallet. In a significant departure from the prior art, the strike plate is secured to the forklift by an upper latch block and a lower latch block with front accessible bolts. While the upper latch block is affixed to the strike plate, the lower latch block is separable and is attached only after the strike plate has been latched over an upper carriage rail of the forklift.

Both the affixed upper latch block and separable lower latch block have angled faces, allowing them to accommodate carriage rails of varying dimensions. In particular, the angled face separable lower is secured to the strike plate by a bolt after the strike plate has been positioned with the upper latch block hung over the top carriage rail. As the lower latch block bolts are tightened, the angled face of the lower latch block engages the lower carriage rail so that, when the bolt is fully tightened, the strike plate and lower latch block are rigidly secured to the lower carriage rail and forklift.

### BRIEF DESCRIPTION OF THE DRAWINGS

FIG. 1 is a perspective view of a typical forklift.

FIG. 2 is a perspective view of a typical pallet.

FIGS. 3A, 3B and 3C are schematic illustrations showing a forklift about to engage a pallet, properly engaging a pallet, and overtravelling into a pallet, causing damage thereto.

FIG. 4 is a frontal illustration of a forklift with a strike plate attached.

FIG. 5 is an exploded side view of a strike plate and detached lower latch block.

FIG. 6 is a detailed side view of a strike plate attached to upper and lower carriage rails.

FIG. 7 is a front perspective view of strike plate illustrating an upper bolt engaging a toothed upper carriage rail.

FIG. 8 is a side view showing the benefit of the strike plate preventing the ripping off of planks from the top deck of a pallet.

### DETAILED DESCRIPTION OF THE INVENTION

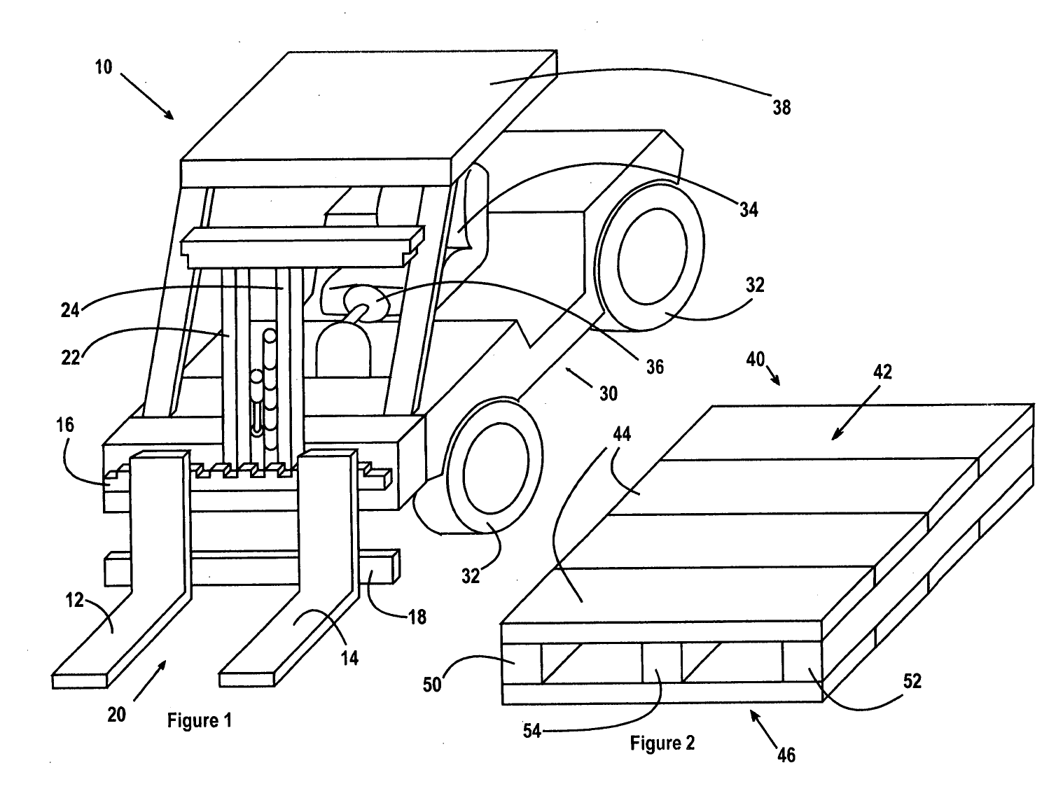

The present invention relates to an attachment to a typical forklift 10 as is used in warehouse and manufacturing facilities around the world. The forklift 10 comprises two L-shaped forks 12, 14 which are mounted to an upper carriage rail 16 and lower carriage rail 18. The entire fork assembly 20, comprising the forks 12, 14 and carriage rails 16, 18 move vertically along vertical posts 22, 24, as illustrated by directional arrows in FIG. 1. The fork assembly 20 and the vertical posts 22, 24 are mounted to the front of a mobile vehicle 30 having wheels 32, an operator seat 34, a steering wheel 36 and a safety roof 38.

The forklift 10 is most often used to transport items placed on a pallet 40 (see FIG. 2). The pallet 40 comprises a top deck 42 having multiple plank boards 44 and a lower deck 46 comprising multiple plank boards 48. Between the top deck 42 and lower deck 46 there are positioned outside structural members 50, 52 and a middle structural member 54. The structural members 50, 52, 54 run substantially perpendicular to the top deck planks 44 and lower deck planks 48, as shown in FIG. 2, with a first void 56 formed between the structural members 50 and 54 and a second void 58, formed between structural members 52 and 54.

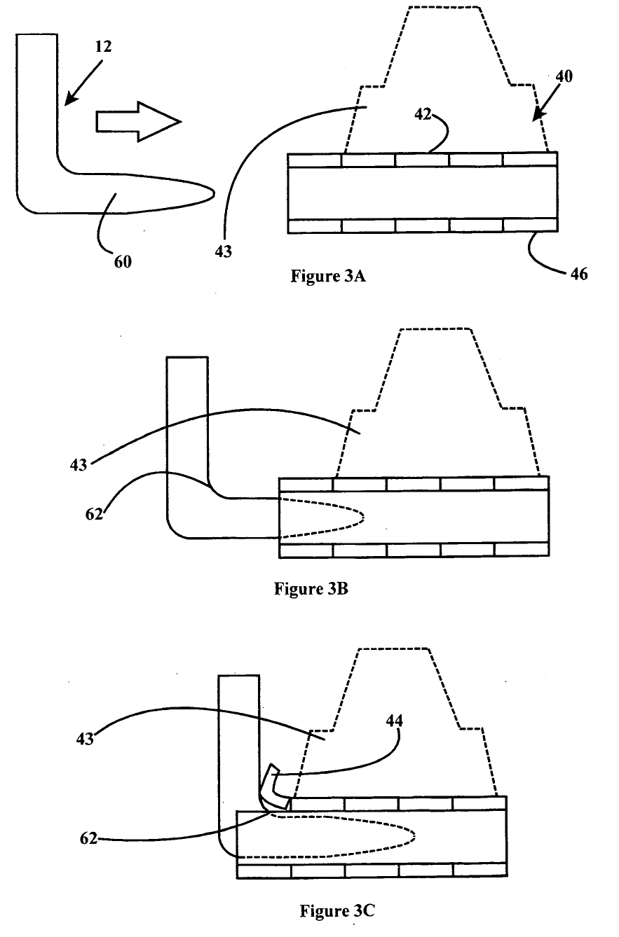

In use, the forklift 10 and pallet 40 are employed by positioning items to be transported on top of the pallets 40, the transportation being done by forklifts 10 which are driven so that the forks 12, 14 engage the voids 56, 58 in the pallet 40. As illustrated in FIG. 3A, the horizontal leg 60 of the fork 12 moves into the pallet 40 between the upper deck 42 and lower deck 46.

The operator of the forklift 10 continues to drive the forks 12, 14 into the pallet 40 as shown in FIG. 3B until the forks 12, 14 are completely engaging the pallet 40. Unfortunately, because the operator's view of the forks 12, 14 entering the pallet 40 is obstructed as a result of his sitting on the seat 34 above the forks 12, 14 and behind the vertical posts 22, 24, he must either guess when the forks 12, 14 are in complete engagement or must get out and visually check. When handling hundreds of loads a day, it is not efficient or even feasible for an operator to get out and check every single time, so operators do by feel and estimate, at the cost of the damage to the pallets resulting from overtravel of the forklift.

The situation presented in FIGS. 3A-3C often results wherein forks 12, 14 are driven too far into the pallet 40 so that the bend 62 in the fork 12 overtravels in a direction shown and strikes the plank 44 on the top deck 42. Because of the angle of the bend 62, the plank 44 is ripped off the top of the pallet 40, leaving it damaged or destroyed. In some situations, if a load 43 is positioned on the pallet 40 near the edge engaged by the forklift, as shown in FIGS. 3A-3C, the damage to the pallet 40, such as tearing off plank board 44, can also cause the load 43 to shift and become unstable and dangerous.

While the damage to the pallet 40 is undesirable, though, forklift operators will still generally opt to overtravel into a pallet 40 and damage it instead of risking not going far enough. The risks of not going far enough can mean a load not properly positioned or counterbalanced on the fork that presents a safety risk. Since the weight of the load is cantilevered on the forks 12, 14, it is critical to have the forks 12, 14 completely into the pallet 40. Thus, the challenge and motivation for the present invention is to provide an arrangement whereby forklifts can safely and securely pick up and transport loads without damaging pallets.

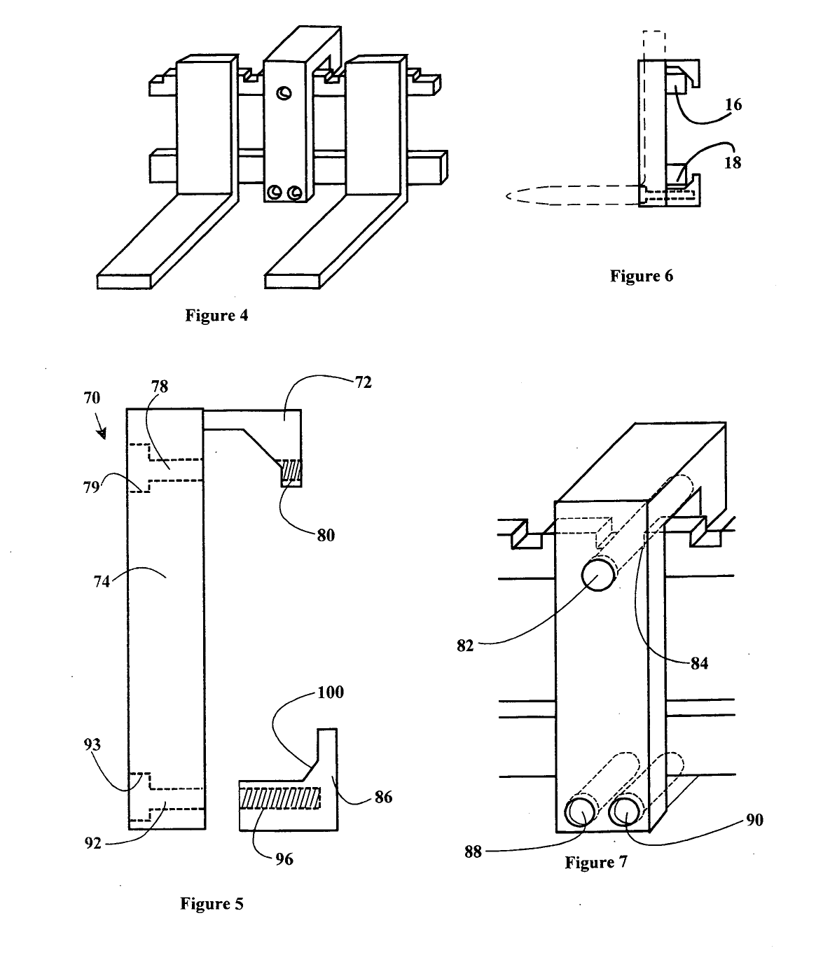

The present invention solves this problem with a strike plate 70, comprising an elongated plate 74, which attaches to the upper carriage rail 16 and lower carriage rail 18 as shown in FIG. 4. The strike plate 70 has a means for securing it to the upper carriage rail 16 comprising a latch block 72 which is either permanently affixed to the vertical plate 74 of the strike plate assembly 70, such as by welding or other equivalent bonding means, or the block 72 is formed with the vertical plate 74 as a single piece of material by casting, molding or milling. The permanently affixed latch block 74 engages the upper carriage rail 16 as shown in FIG. 6.

In an important aspect of the present invention, the means for securing the strike plate comprises a through bolt channel 78 formed in the vertical plate 74 near the top end as shown in FIG. 5, which aligns with a threaded sleeve 80 formed in an affixed latch block 72. This is important because a locking bolt 82, inserted through the channel 78 and threaded into the sleeve 80 locks the position of the strike plate 70 by engaging a tooth indentation 84 in the upper carriage rail 16 (FIG. 7). The cooperative interaction between the upper latch block 72, the 82, and the toothed upper carriage rail 16 is important and distinguishes the present invention from the prior art because the positioning of the upper locking bolt 82 between the teeth 84 provides not only a means for affixing the strike plate 70 to the upper carriage rail 16, it also provides a means for establishing a lateral position on the carriage rail 16 between the forks 12, 14 to coincide with the location with the middle structural member 54 of a pallet 40, as well as providing a means for preventing lateral translation of the strike plate 70 along the upper carriage rail 16.

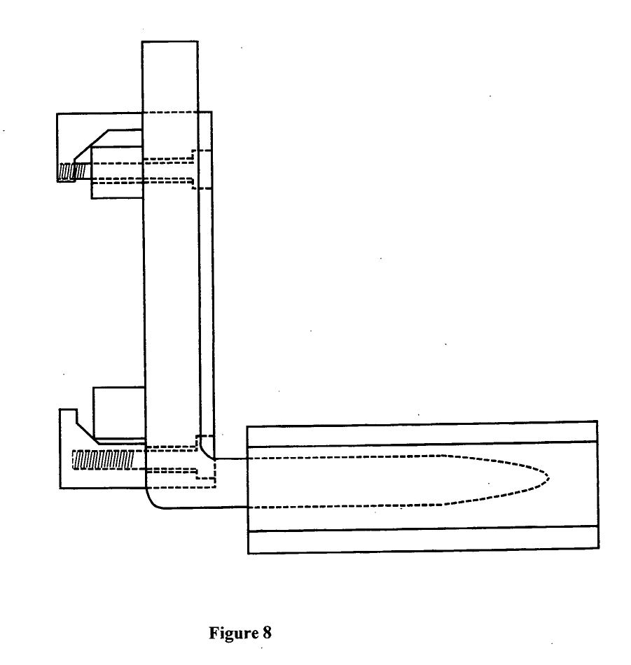

Once the position of the strike plate 70 is established and the upper locking bolt 82 is installed on the upper carriage rail 16 between the teeth 84, additional provisions of the means for securing the strike plate 70 to the carriage rail and forklift are implemented. Specifically, a bottom latch block 86 is bolted to the elongated vertical plate 74 as shown in FIGS. 5, 6 and 7 by two bolts 88, 90. The bolts 88, 90 extend through channels 92, 94 and line up with threaded sleeves 96, 98 in the lower latch block 86. The lower latch block 86 clamps onto the lower carriage rail 18 without requiring anything other than front access to establish and tighten the connection of the strike plate 70 to the lower carriage rail 18. That is, to tighten the locking bolts 88, 90, they are first positioned in and through the unthreaded bolt channels 92, 94. Next, the separable lower latch block 86 is positioned by the operator so that the threaded sleeves 96, 98 in the lower latch block 86 are engaged by the locking bolts 88, 90. The bolts 88, 90 are then tightened from the front side of the forklift only, ultimately bringing the separable lower latch block 86 into tight face-to-face engagement with the bottom carriage rail 18. The angled face 100 of the lower latch block 86 engages the lower carriage rail 18 as shown in FIG. 8 such that, as the lower locking bolts 88, 90 are tightened down in threaded sleeves 96, 98, the assembly of the strike plate 70 and lower latch block 86 clamps snugly onto the lower carriage rail 18. This clamping by tightening of the bolts 88, 90 between the strike plate 70 and the lower latch block 86, with the angled face 100, provides a means for affixing the strike plate 70 to the lower carriage rail without requiring any modification, drilling or adjustments to the lower carriage rail 18. Applied cooperatively with the lateral locking means applied to the upper carriage rail 16, the means for affixing the strike plate 70 to the lower carriage rail 18 provides a reliable and secure means and method for securing the strike plate attachment to the forklift without requiring any access to the rear of the carriage rails 16, 18. This is a significant departure from the prior art.

In use, once the strike plate 70 has been applied and positioned on a forklift, damage to pallets 40 is prevented or eliminated because the strike plate 70 engages the middle structural member 54 of a pallet prior to the vertical section of the forks 12, 14, or the bend 62 in the forks 12, 14, engaging the deck planks 44 of the upper deck 42 of the pallet 40. Damage to pallets, necessitating expensive repairs or replacements, will thus be eliminated by providing a simple, easy to install strike plate 70. The unthreaded bolt holes 78, 92, 94 in the strike plate 70 are all provided with recessed collars as shown in FIG. 5. The recessed collars 79, 93 are provided and sized so that a wrench, ratchet or socket can be used to tighten bolts therein. In addition, the recessed collars 79, 93 are sufficiently deep so that the heads of the bolts 82, 88, 90 are flush with or below the surface of the strike plate 70. This will prevent the bolts 82, 88, 90 from striking products or loads positioned on the pallet 40, which is beneficial for two reasons. First, there will not be any damage to the palletized goods from being struck by, scratched or scuffed by the heads of the bolts 82, 88, 90. Second, the bolts 82, 88, 90 will not be contacted and dislodged or unscrewed as a result of being stuck by the palletized load, and will thus remain tightly engaged to keep the strike plate 70 rigidly affixed and properly positioned to the forklift.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

I claim:

1. A strike plate for a forklift having at least one carriage rail comprising:
an elongated plate;
means for securing said elongated plate to said at least one carriage rail;
wherein said means for securing are accessible from the front of said forklift.

2. The strike plate as set forth in claim 1 wherein said means for securing further comprises a means for preventing lateral translation of said strike plate.

3. The strike plate as set forth in claim 2 wherein said means for securing further comprises a means for affixing said strike plate to a lower carriage rail of said forklift.

4. The strike plate as set forth in claim 3 wherein said means for securing further comprises at least one latch block separable from said strike plate.

5. The strike plate as set forth in claim 4 wherein said means for securing further comprises one permanently affixed latch block affixed near a top end of said strike plate.

6. The strike plate as set forth in claim 4 wherein said at least one latch block further comprises a threaded sleeve.

7. The strike plate as set forth in claim 6 wherein said strike plate further comprises a through hole having a recessed collar.
